(19) United States
(12) Patent Application Publication
(10) Pub. No.: US 2026/0302802 A1
(43) Pub. Date: Oct. 1, 2026

(54) MULTI-INPUT ELECTRICAL ENERGY STORAGE SYSTEM AND METHOD

(71) Applicant: Yosef Microtnik, Las Vegas, NV (US)

(72) Inventor: Yosef Microtnik, Las Vegas, NV (US)

(21) Appl. No.: 19/097,848

(22) Filed: Apr. 1, 2025

(51) Int. Cl. H02J 7/35; F03B 13/06; F03B 15/08; H02J 7/00

(52) U.S. Cl. CPC H02J 7/35; F03B 13/06; F03B 15/08; H02J 7/50; H02J 2101/24; H02J 2101/40

(57) ABSTRACT

The invention provides a multi-input energy storage system having a solar energy system for storing electrical energy using a solar regulator into a first battery storage system used in conjunction with a water wheel energy system uses a water wheel regulator for storing energy into a second storage battery pack. The first solar battery delivers power to a water pump through a pump controller utilized by the water wheel energy system to pump water to turn the water wheel which in turns store electrical energy through a water wheel regulator for delivering water wheel power into a second storage battery for later delivery to a load. The water wheel regulator further turns off and on the alternator at specified RPM levels such that the water wheel alternator does not over heat and burn out.

### FIELD OF THE INVENTION

The invention pertains to the field of renewable energy utilization and storage, and particularly relates to a multi-input electrical energy storage system based on a storage battery pack and a control method thereof.

### BACKGROUND OF THE INVENTION

With the development of social economy and the improvement of the living standard of people, the demand of people on energy is continuously increased, the existing power generation technology is gradually difficult to meet the living needs, meanwhile, the continuous improvement of the prices of traditional petrochemical energy sources such as petroleum and coal and the like and the influence of the traditional petrochemical energy sources on the global climate and the environment in the combustion process are increasingly concerned, and the development and the utilization of new energy sources and renewable energy sources are inevitable trends in terms of the development needs of resources, environments and society. In a new renewable energy family, solar energy, and water wheel energy used together provide an inexhaustible source of clean energy and has the advantages of large power, high efficiency, simple process, low cost and small ecological influence, so that the development potential is huge.

However, no matter the solar energy or the water wheel energy is used for power supply at present, the power generation mode is single, and the defects that the power generation mode is greatly influenced by external factors exist, for example, the solar energy cannot be used for power supply in rainy days, Water wheels are not as efficient as modern hydroelectric technologies. They have lower conversion efficiencies, meaning a larger portion of the potential energy in the water flow is not converted into usable electrical energy. Therefore, the power generation and energy storage system of combining both systems becomes low in efficiency, and the power supply is unstable.

Therefore, what is needed is a new and approved renewable electrical energy utilization and storage system that combines both solar and water wheel energy sources. The present invention solves all these problems in a new and unique fashion.

### SUMMARY OF THE INVENTION

The invention provides a multi-input energy storage system having a solar energy system for storing electrical energy using a solar regulator into a first battery storage system used in conjunction with a water wheel energy system uses a water wheel regulator for storing energy into a second storage battery pack. The first solar battery delivers power to a water pump through a pump controller utilized by the water wheel energy system to pump water to turn the water wheel which in turns store electrical energy through a water wheel regulator for delivering water wheel power into a second storage battery for later delivery to a load. The water wheel regulator further turns off and on the alternator at specified RPM levels such that the water wheel alternator does not over heat and burn out.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that the drawings depict only illustrated embodiments of the invention and therefore not to be considered limiting of its scope. The invention will be described and explained with additional specificity and detail through use of the accompanying drawings in which:

FIG. 1 is a system graphical schematic diagram of a multi-input electrical energy storage system based in accordance with the present invention.

FIG. 2 is a graphical side view of a water wheel connected to an alternator through an alternator regulator in accordance with the multi-input electrical energy storage system shown in FIG. 1.

### DESCRIPTION OF THE INVENTION

The following description is presented to enable a person skilled in the art to make and use the invention and is provided in the context of a particular application and its requirements. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Various terms are used herein. To the extent a term used in a claim is not defined below, it should be given the broadest definition persons in the pertinent art have given that term as reflected in printed publications and issued patents at the time of filing.

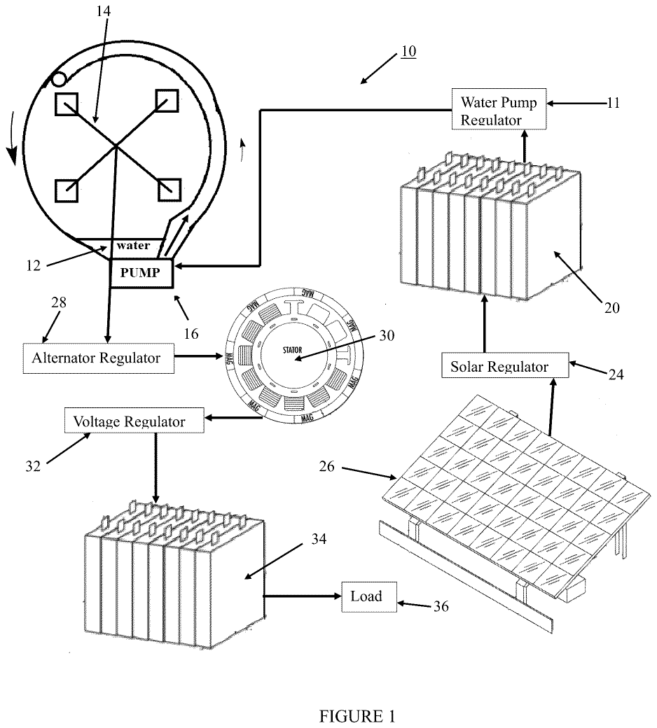

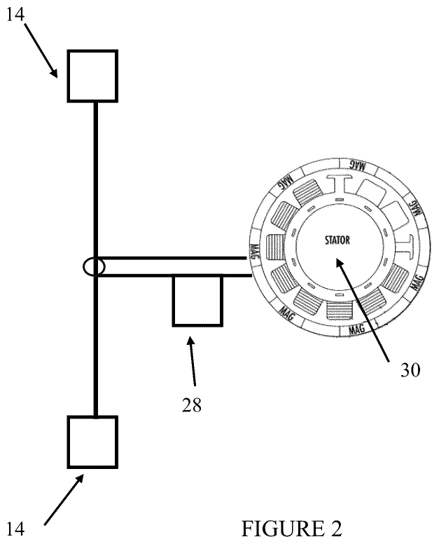

Referring now to FIGS. 1 and 2, there is shown a multi-input electrical energy storage system 10 for charging a second storage battery or storage load battery pack 34 for power delivery to a load 36. The multi-input power generation system 10 comprises a water wheel power generation system 14 housed in a water reservoir 12 utilizing a water pump 16 that feeds electrical current to an alternator 30 through an alternator regulator 28 for delivering charge to second storage battery pack 34. A solar power array system 26 is used in combination with the water wheel power generation system 14. Referring once again to FIG. 1, the solar power generation system comprises a solar photovoltaic power array 26 and a solar regulator 24 for charging a first battery storage system 20 which provides power through a water pump regulator 11 to a water pump 16 to turn the water wheel power generation device 14 using water housed in a water reservoir 12. The water wheel obtained electric energy is achieved by turning a water wheel alternator 30 controlled through a alternator regulator 28, so that the second storage battery pack 34 is charged with stable current, the second storage battery pack 34 is composed of positive and negative electrodes and is managed by the alternator regulator 28 to monitor the maximum temperature rise, the maximum temperature difference and the electric quantity state of the second battery system 34. The second storage battery pack 34 delivers power to a load 36 which may be by example a television, refrigerator, radio or any device requiring electrical power.

In summary, the multi-input electrical energy storage system of the present invention comprises a solar energy system 26 for storing electrical energy using a solar regulator 24 into a first battery storage system 20 wherein the first solar battery 20 delivers power to a water pump 16 through a water pump regulator 11 utilized by the water wheel energy system 14 to pump water to turn a water wheel 14 which in turns stores electrical energy using a water wheel alternator 30 through a alternator regulator 28 for delivering water wheel power into a second storage battery 34 for later delivery to a load.

The water wheel regulator 28 further turns off and on the water wheel alternator 30 at a specified RPM level such that the water wheel alternator 30 does not over heat and burn out. More specifically, the water wheel regulator 32 further turns off the water wheel alternator 30 when the water wheel alternator 30 reaches 65 RPM. Additionally, the alternator regulator 28 further turns on the water wheel alternator 30 for delivering power to the second storage battery 34 when the water wheel alternator 30 reaches 15 RPM or greater. It should be understood that the water pump 16 pumps water from a water reservoir 12 to turn the water wheel 14 which dumps the water back into the water reservoir 12 for further use by the water pump 16. Lastly, the solar energy system includes a solar photovoltaic power array 26 and solar regulator 24 for charging the first battery storage system 20 which provides power through a water pump regulator 11 to the water pump 16 to turn the water wheel power generation device 14.

When the second storage battery 34 is charged, the storage battery 34 is independently connected to supply power to the household alternating current load 36, the second storage battery 34 may also be leased in a time-sharing manner, after the second storage battery pack 34 is charged, part of fully charged storage battery energy is leased to a user for use, and after the storage battery pack 34 is used, the second storage battery 34 is recharged again, so that the second storage battery pack 34 is recycled.

More specifically, the present invention provides a multi-input electrical energy storage system utilizing a storage battery pack. The multiple input power generation system is mainly composed of: the solar photovoltaic power generation device 10, the solar panel control switch 14, said water wheel power generation device 12, the water wheel driven generator control switch 15, said energy storage system charge controller 17, said storage battery mainly comprises: a said storage battery 18 and a battery management system 19. The new energy power generation systems in the multi-input power generation system are controlled and utilized by a system charging controller 17 and work together in a matched mode.

The second storage battery 34 is powered by the multi-input power generation system, electric energy is rectified by the alternator regulator 28 and then charged into the second storage battery 34, wherein the storage battery 34 may independently supply power to a household alternating current load, the voltage regulator 32 controls the maximum temperature rise and the maximum temperature difference of the second storage battery 34 and monitors the electric energy in real time, and the important function of protecting the second storage battery 34 is achieved. The invention effectively solves the defects of low utilization efficiency and unstable output of renewable energy sources by combining and using a plurality of energy sources, and the characteristic that the second storage battery 34 is used instantly to ensure that the system 10 may be built in remote underdeveloped areas of the power grid

No limitation with regard to the described aspects or embodiments of the present invention is intended. Many modifications to the depicted embodiments may be made without departing from the spirit and scope of the present invention. Accordingly, the foregoing description is intended to be illustrative rather than restrictive. The invention described herein is defined by the appended claims and all changes to the invention that fall within the meaning and the range of equivalency of the claims are embraced within their scope.

What is claimed is:

1. A multi-input electrical energy storage system and method, comprising:
A solar energy system for storing electrical energy using a solar regulator into a first battery storage system;
a water wheel energy system; wherein
said first solar battery delivers power to a water pump through a water pump regulator utilized by said water wheel energy system to pump water to turn a water wheel which in turns stores electrical energy using a water wheel alternator through a alternator regulator for delivering water wheel power into a second storage battery for later delivery to a load.

2. The multi-input electrical energy storage system according to claim 1, wherein said water wheel regulator further turns off and on said water wheel alternator at a specified RPM level such that said water wheel alternator does not over heat and burn out.

3. The multi-input electrical energy storage system according to claim 1, wherein said water wheel regulator further turns off said water wheel alternator when said water wheel alternator reaches 65 RPM.

4. The multi-input electrical energy storage system according to claim 1, wherein said alternator regulator further turns on said alternator for delivering power to said second storage battery when said water wheel alternator reaches 15 RPM or greater.

5. The multi-input electrical energy storage system according to claim 1, wherein said water pump pumps said water from a water reservoir to turn said water wheel which dumps said water back into said water reservoir for further use by said water pump.

6. The multi-input electrical energy storage system according to claim 1, wherein said solar energy system having a solar photovoltaic power array and said solar regulator for charging said first battery storage system which provides power through a water pump regulator to a water pump 16 to turn the water wheel power generation device.

7. A method for providing energy storage, comprising the steps of:
storing electrical energy using a solar energy system through a solar regulator into a first battery storage system;
delivering power to a water pump from said first solar battery through a water pump regulator;
pumping water using said water pump from a water reservoir to turn a water wheel which in turns creates electrical energy using a water wheel alternator through a alternator regulator for delivering water wheel power into a second storage battery for later delivery to a load.

8. The multi-input electrical energy storage system according to claim 7, further comprising the step of:
turning off and on said water wheel alternator at a specified RPM level such that using said alternator regulator wherein said water wheel alternator does not over heat and burn out.

9. The multi-input electrical energy storage system according to claim 7, further comprising the step of:
turning off said water wheel alternator when said alternator reaches 65 RPM using said alternator regulator.

10. The multi-input electrical energy storage system according to claim 7, further comprising the step of:
turning on said alternator using said alternator regulator for delivering power to said second storage battery when said alternator reaches 15 RPM or greater.

11. The multi-input electrical energy storage system according to claim 7 further comprising the step of:
Pumping water using said water pump from a water reservoir to turn said water wheel which dumps said water back into said water reservoir for further use by said water pump.

12. The multi-input electrical energy storage system according to claim 7, further comprising the step of:
charging said first battery storage system utilizing said solar energy system having a solar photovoltaic power array and said solar regulator for providing power through a water pump regulator to a water pump to turn said water wheel power generation device.
